(19) United States
(12) Patent Application Publication
(10) Pub. No.: US 2011/0013853 A1
(43) Pub. Date: Jan. 20, 2011

(54) APPROACH FOR DETERMINING MOTION VECTOR IN FRAME RATE UP CONVERSION

(75) Inventor: Ying-Ru CHEN, Tainan County (TW)

Correspondence Address: REN-SHENG INTERNATIONAL, 7F, NO. 57, SEC. 2, DUNHUA S. ROAD, TAIPEI, 106, TW

(73) Assignee: HIMAX TECHNOLOGIES LIMITED, Tainan County (TW)

(21) Appl. No.: 12/504,686

(22) Filed: Jul. 17, 2009

(51) Int. Cl. G06K 9/36

(52) U.S. Cl. 382/236

(57) ABSTRACT

One embodiment of the present invention sets forth a method for determining a first motion vector for a first block in a first frame. The method includes selecting a plurality of candidate blocks corresponding to the first block and a first set of candidate motion vectors for the plurality of candidate blocks from a reference frame, selecting one or more neighbor blocks neighboring the first block and a second set of motion vectors for the one or more neighbor blocks from the first frame, calculating an index based on a difference between the first block and the each candidate block, a reliability factor associated with the second set of the motion vectors, a first distance between the first block and each of the one or more neighbor blocks, and a second difference between each of the first set of candidate motion vectors and each of the second set of the motion vectors for each of the plurality of candidate blocks, selecting a matching block corresponding to the first block from the plurality of candidate blocks based on the indexes, and determining the first motion vector according to the matching block.

### BACKGROUND OF THE INVENTION

1. Field of the Invention

The present invention generally relates to video processing, and more particularly to an approach for determining a motion vector in frame rate up conversion.

2. Description of the Related Art

Unless otherwise indicated herein, the approaches described in this section are not prior art to the claims in this application and are not admitted to be prior art by inclusion in this section.

Frame rate conversion generally refers to a process of converting materials originated from one frame rate to a different frame rate. To support a high frame rate display, a frame rate up conversion (FRUC) may be performed to convert a low frame rate video signal into a high frame rate video signal. In FRUC, interpolated frames are generated using frames received at a low frame rate as the reference. Currently, the interpolation process may be performed based on the motion vectors of the received frames obtained through motion compensation schemes, so that moving objects within the interpolated frames may be correctly positioned. Although the motion-compensated FRUC offers some advantages, it also suffers artifacts when motion estimation is incorrect, especially when the received frames are complex or speedy.

What is needed in the art is thus an approach that can determine the motion vectors for the frame used as the reference for the preparation of the interpolated frame in a manner ensuring reliable motion estimation for FRUC and address at least the problems set forth above.

### SUMMARY OF THE INVENTION

One embodiment of the present invention sets forth a method for determining a first motion vector for a first block in a first frame. The method includes selecting a plurality of candidate blocks corresponding to the first block and a first set of candidate motion vectors for the plurality of candidate blocks from a reference frame, selecting one or more neighbor blocks neighboring the first block and a second set of motion vectors for the one or more neighbor blocks from the first frame, calculating an index based on a difference between the first block and the each candidate block, a reliability factor associated with the second set of the motion vectors, a first distance between the first block and each of the one or more neighbor blocks, and a second difference between each of the first set of candidate motion vectors and each of the second set of the motion vectors for each of the plurality of candidate blocks, selecting a matching block corresponding to the first block from the plurality of candidate blocks based on the indexes, and determining the first motion vector according to the matching block.

At least one advantage of the present invention disclosed herein is by establishing a reliable motion vector for a block, so that an interpolated frame may also be established based on the reliable motion vector.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the accompanying drawings. It is to be noted, however, that the accompanying drawings illustrate only typical embodiments of this invention and are therefore not to be considered limiting of its scope, for the invention may admit to other equally effective embodiments.

FIG. 1 is a simplified block diagram showing an example video subsystem in a computing device, according to one embodiment of the present invention;

FIG. 2A is a schematic diagram showing example relationships among a first frame, a second frame, and an interpolated frame and blocks in such frames in terms of time and locations;

FIG. 2B is a schematic diagram showing movement of an image from a first frame to a second frame;

FIG. 3 is a schematic diagram showing the relationships among blocks in a reference frame, an interpolated frame, and a first frame, according to one embodiment of the present invention;

FIG. 4 is a flow chart showing an example process for determining a first motion vector for a first block in a first frame, according to one embodiment of the present invention; and

FIG. 5 is a schematic diagram showing an example computer program product configured to determine a motion vector, according to one embodiment of the present invention.

### DETAILED DESCRIPTION

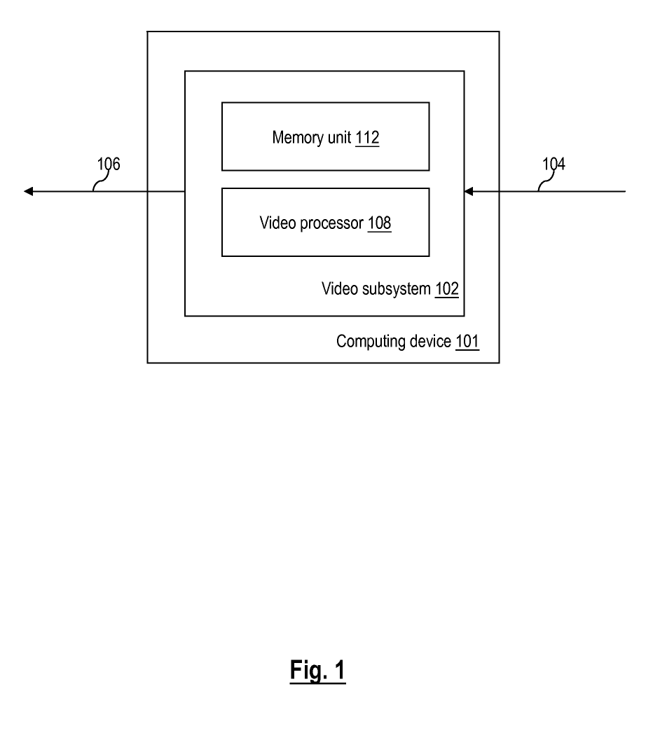

FIG. 1 is a simplified block diagram showing an example video subsystem 102 in a computing device 101, according to one embodiment of the present invention. The video subsystem 102 is configured to receive a sequence of incoming video frames 104, process the sequence of incoming video frames 104, and output a sequence of outgoing video frames 106. The video subsystem 102 includes a video processor 108 and a memory unit 112. The video processor 108 is configured to perform functions such as, without limitation, determining motion vectors for video frames and preparing one or more interpolated frames so that the interpolated frames to be outputted as a part of the outgoing video frames 106.

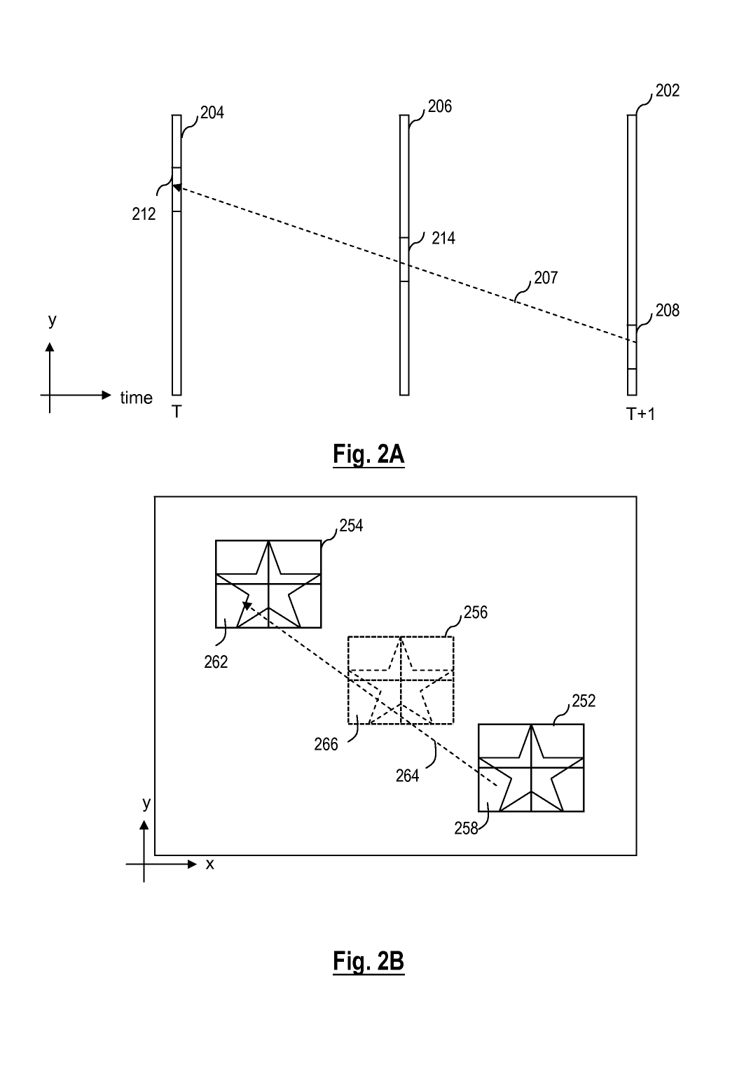

In conjunction with FIG. 1, FIG. 2A is a schematic diagram showing example relationships among a first frame, a second frame, and an interpolated frame and blocks in such frames in terms of time and locations. The first frame 202 and the second frame 204 could be a part of the incoming video frames 104. The interpolated frame 206 may be inserted between the first frame 202 and the second frame 204 before being outputted as a part of the outgoing video frames 106. In FIG. 2A, the second frame 204 refers to the video frame that is received by the video subsystem 102 prior to the first frame 202. For example, the second frame 204 may be received at time T, and the first frame 202 is received and being processed at time T+1. In the illustration shown in FIG. 2A, the second frame 204 may serve as a reference frame for the preparation of the interpolated frame 206. However, another video frame (not shown in FIG. 2A), which may be received at a different time than T, may server as the reference frame.

Each of the first frame 202 and the second frame 204 could be divided into a plurality of blocks. A block 208 is an example block in the first frame 202, and a block 212 is an example in the second frame 204. Processing of the first frame 202 includes determining a motion vector (e.g., motion vector 207) for the block 208. Suppose the block 212 corresponds to the block 208. The motion vector 207 for the block 208 may help to identify an interpolated block 214 in the interpolated frame 206. Thus, with the motion vectors for the blocks in the first frame 202, the corresponding blocks in the interpolated frame 206 may be determined as the result.

FIG. 2B is a schematic diagram showing movement of an image from a first frame 252 to a second frame 254. An interpolated frame 256 is prepared on the basis of the first frame 252 and the second frame 254. In one implementation, the motion vectors for the blocks in the first frame 252 may be utilized to prepare the interpolated frame 256. Specifically, the first frame 252 may include one or more blocks such as a block 258, which corresponds to a block 262 in the second frame 254. With a motion vector 264 for the block 258, an interpolated block 266 in the interpolated frame 256 may be prepared on the basis of the location of the block 258 and the motion vector 264.

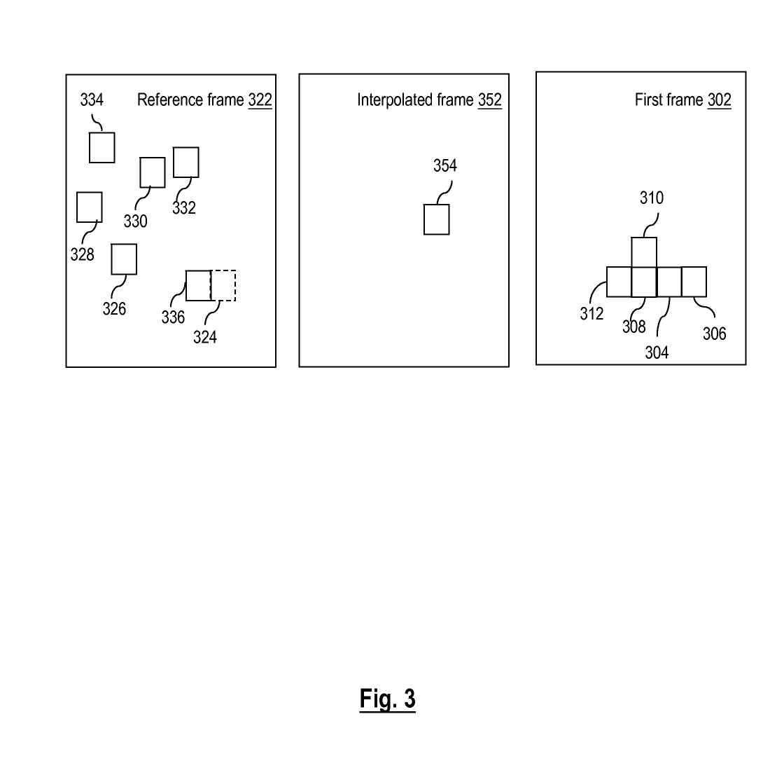

FIG. 3 is a schematic diagram showing the relationships among blocks in a reference frame 322, an interpolated frame 352, and a first frame 302, according to one embodiment of the present invention. Similar to the time sequence shown in FIG. 2A, as an illustration, a reference frame 322 may be received prior to the first frame 302. The first frame 302 may include a set of blocks, such as a first block 304 and its neighbor blocks 306 and 308. The neighbor blocks 306 and 308 may also have their own set of neighbor blocks. For example, the blocks neighboring the block 308 may include, without limitation, neighbor blocks 310 and 312.

The reference frame 322 may also include a plurality of the blocks. For the determination of the first motion vector for the first block 304, in one implementation, a corresponding block 324 within the reference frame 322 is located. In addition, the reference frame 322 also includes several candidate blocks, such as candidate blocks 326, 328, 330, 332, and 334. Each of the candidate blocks 326, 328, 330, 332, and 334 may be associated with an index, and a matching block may be selected from the candidate blocks on the basis of the index. The motion vector established based on the selected matching block and the corresponding block 324 may be the first motion vector for the first block 304.

With the selected matching block and the first block 304 and their motion vectors, an interpolated block 354 in an interpolated frame 352 may also be determined. The aforementioned mentioned candidate blocks may refer to blocks that are selected through a block matching algorithm, and the number of such candidate blocks in the reference frame 322 may vary.

In one implementation, the index for each of the candidate blocks, such as the candidate block 326 in the reference frame 322, may be determined based on several factors. One factor to be considered is a first difference (e.g., a sum absolute difference (SAD)) between the candidate block 326 and the first block 304. A candidate block associated with a larger first difference may be less likely to be chosen as the matching block for the first block 304 than another candidate block associated with a smaller first difference.

Another factor to be considered for establishing the index is a second difference between the motion vector for the candidate block 326 and each of a set of motion vectors for the neighbor blocks of the first block 304. The second difference may include a difference in direction and/or a difference in length between the motion vector for the candidate block 326 and each of the set of motion vectors for the neighbor blocks of the first block 304. In other words, if the motion vector for a candidate block and the motion vector for a particular neighbor block of the first block 304 point to the same or substantially similar direction, such a candidate block may be more likely to be selected as the matching block for the first block 304. Similarly, if the motion vector for a candidate block is similar in length as the motion vector for a certain neighbor block of the first block 304, then such a candidate block may also be more likely to be selected as the matching block for the first block 304.

Yet another factor to be considered for establishing the index is a reliability factor associated with each of the motion vectors for the neighbor blocks of the first block 304. The reliability factor may be computed based on a third difference (e.g., SAD) between a matching block of the neighbor block identified in the reference frame 322 and the neighbor block itself and a fourth difference between the motion vector for such a neighbor block and the motion vector for a particular neighbor of the neighbor block in the first frame 302. To illustrate, suppose the neighbor block of the first block 304 in interest is the neighbor block 308. Suppose further that the matching block for the neighbor block 308 is a block 336 in the reference frame 322, and the blocks neighboring the neighbor block 308 are the neighbor blocks 310 and 312. When the third difference between the matching block 336 and the neighbor block 308 is large, the neighbor block 308 is less likely to be selected, because it may be viewed to be less reliable. Similarly, when the fourth difference between the motion vector for the neighbor block 308 and the motion vector for the neighbor block 310 (or the neighbor block 312) is large, the neighbor block 308 may also be less likely to be selected.

Still another factor to be considered for establishing the index may be a distance between the first block 304 and the neighbor blocks of the first block, such as the neighbor blocks 306 and 308. The longer the distance is, the less likely the neighbor block and its motion vector may be selected.

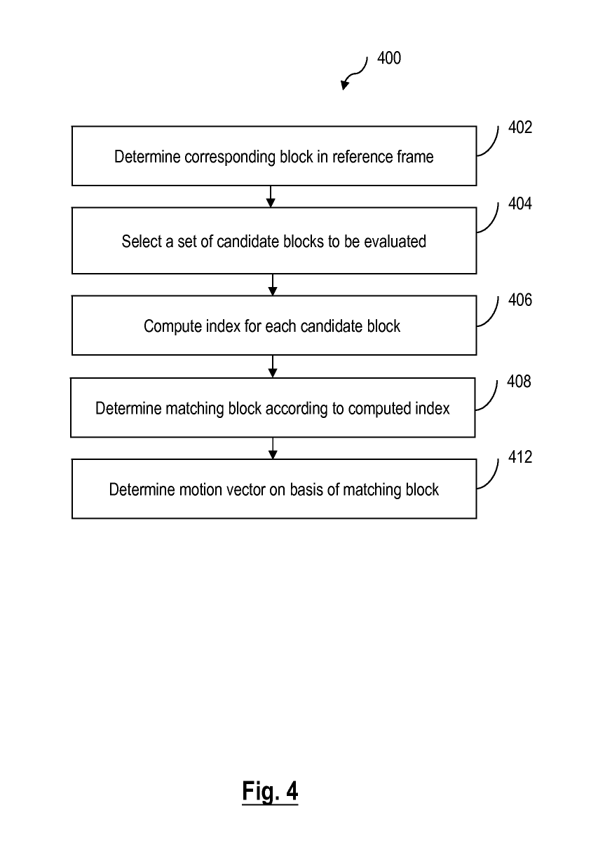

FIG. 4 is a flow chart showing an example process 400 for determining a first motion vector for a first block in a first frame, according to one embodiment of the present invention. In operation 402, the process 400 determines a corresponding block in a reference frame for the first block. In operation 404, the process 400 selects a set of candidate block to be evaluated to see if one of candidate blocks could be a matching block for the first block. In operation 406, the process 400 computes an index for each of the selected candidate blocks. In one implementation, the index for each of the candidate blocks is computed based on one or more of (1) a difference between the first block and the candidate block, (2) a reliability factor associated with each of the motion vectors for the neighbor blocks of the first block, (3) a first distance between the first block and each of its neighbor blocks, and (4) a second difference between the motion vector for the candidate block. In operation 408, the process 400 determines the matching block on the basis of the computed index. More specifically, the process 400 compares the indices of the set of candidate blocks. In one implementation, the candidate block associated with the smallest index value is selected as the matching block. With the matching block, the first motion vector for the first block may be determined. Given that an interpolated frame is between the reference frame and the first frame, with the matching block in the reference frame and the first motion vector for the first block, an interpolated block in the interpolated frame may also be determined.

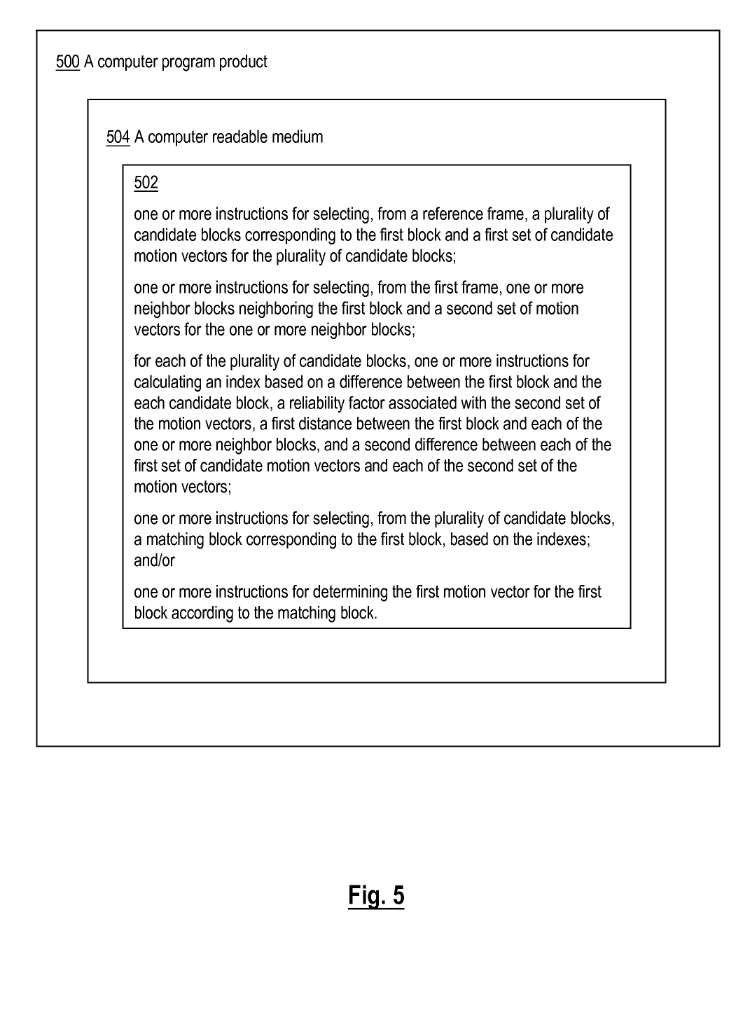

FIG. 5 is a schematic diagram showing an example computer program product 500 configured to determine a motion vector, according to one embodiment of the present invention. Computer program product 500 includes one or more sets of instructions 502 for executing a motion estimation method of determining a first motion vector for a first block in a first frame. For illustration only, the instructions 502 may reflect one of the methods described above and illustrated in FIG. 4. Computer program product 500 may be recorded in a computer readable medium 504. According to one embodiment of the present invention, the computer program product 500 may be used with a video processing subsystem in a computing device. Illustrative computer readable media include, but are not limited to: (i) non-writable storage media (e.g., read-only memory devices within a computer such as CD-ROM disks readable by a CD-ROM drive, ROM chips, or any type of solid-state non-volatile semiconductor memory) on which information is permanently stored; and (ii) writable storage media (e.g., floppy disks within a diskette drive, CD-RW disks, DVD-RW disks, flash memory, hard-disk drive, or any type of solid-state random-access semiconductor memory) on which alterable information is stored.

The above examples, embodiments, instruction semantics, and drawings should not be deemed to be the only embodiments, and are presented to illustrate the flexibility and advantages of the present invention as defined by the following claims.

We claim:

1. A motion estimation method for determining a first motion vector for a first block in a first frame, comprising:
selecting, from a reference frame, a plurality of candidate blocks corresponding to the first block and a first set of candidate motion vectors for the plurality of candidate blocks;
selecting, from the first frame, one or more neighbor blocks neighboring the first block and a second set of motion vectors for the one or more neighbor blocks;
for each of the plurality of candidate blocks, calculating an index based on a difference between the first block and the each candidate block, a reliability factor associated with the second set of the motion vectors, a first distance between the first block and each of the one or more neighbor blocks, and a second difference between each of the first set of candidate motion vectors and each of the second set of the motion vectors;
selecting, from the plurality of candidate blocks, a matching block corresponding to the first block, based on the indexes; and
determining the first motion vector for the first block according to the matching block.

2. The method of claim 1, wherein the plurality of candidate blocks is selected based on a block matching algorithm.

3. The method of claim 1, wherein the reference frame precedes the first frame.

4. The method of claim 1, wherein the reliability factor associated with the second set of the motion vectors is determined based on a third difference between each of the one or more neighbor blocks and a matching block corresponding to the each neighbor block and a fourth difference between a first motion vector for the each neighbor block and a second motion vector for a block neighboring the each neighbor block.

5. A frame rate up-conversion method, comprising:
fetching a first frame having a first block;
selecting, from a reference frame, a plurality of candidate blocks corresponding to the first block and a first set of candidate motion vectors for the plurality of candidate blocks;
selecting, from the first frame, one or more neighbor blocks neighboring the first block and a second set of motion vectors for the one or more neighbor blocks;
for each of the plurality of candidate blocks, calculating an index based on a difference between the first block and the each candidate block, a reliability factor associated with the second set of the motion vectors, a first distance between the first block and each of the one or more neighbor blocks, and a second difference between each of the first set of candidate motion vectors and each of the second set of the motion vectors;
selecting, from the plurality of candidate blocks, a matching block corresponding to the first block, based on the indexes;
determining the first motion vector for the first block according to the matching block; and
determining an interpolated block in an interpolated frame between the reference frame and the first frame according to the first motion vector for the first block.

6. The method of claim 5, wherein the plurality of candidate blocks is selected based on a block matching algorithm.

7. The method of claim 5, wherein the reference frame precedes the first frame.

8. The method of claim 5, wherein the reliability factor associated with the second set of the motion vectors is determined based on a third difference between each of the one or more neighbor blocks and a matching block corresponding to the each neighbor block and a fourth difference between a first motion vector for the each neighbor block and a second motion vector for a block neighboring the each neighbor block.

9. A computer readable medium containing a sequence of instructions for determining a first motion vector for a first block in a first frame, which when executed by a processing unit, causes the processing unit to:
select, from a reference frame, a plurality of candidate blocks corresponding to the first block and a first set of candidate motion vectors for the plurality of candidate blocks;
select, from the first frame, one or more neighbor blocks neighboring the first block and a second set of motion vectors for the one or more neighbor blocks;
for each of the plurality of candidate blocks, calculate an index based on a difference between the first block and the each candidate block, a reliability factor associated with the second set of the motion vectors, a first distance between the first block and each of the one or more neighbor blocks, and a second difference between each of the first set of candidate motion vectors and each of the second set of the motion vectors;
select, from the plurality of candidate blocks, a matching block corresponding to the first block, based on the indexes; and
determine the first motion vector for the first block according to the matching block.

10. The computing readable medium of claim 9 further comprising a sequence of instructions, which when executed by the processing unit, causes the processing unit to select the plurality of candidate blocks based on a block matching algorithm.

11. The computing readable medium of claim 9, wherein the processing unit receives the reference frame prior to receiving the first frame.

12. The computing readable medium of claim 9, further comprising a sequence of instructions, which when executed by the processing unit, causes the processing unit to determine the reliability factor based on a third difference between each of the one or more neighbor blocks and a matching block corresponding to the each neighbor block and a fourth difference between a first motion vector for the each neighbor block and a second motion vector for a block neighboring the each neighbor block.
